(19) United States
(12) Patent Application Publication
(10) Pub. No.: US 2007/0069806 A1
(43) Pub. Date: Mar. 29, 2007

(54) Operational amplifier and band gap reference voltage generation circuit including the same

(75) Inventor: Yoon-Jae Shin, Kyoungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Hynix Semiconductor Inc.

(21) Appl. No.: 11/528,966

(22) Filed: Sep. 27, 2006

(30) Foreign Application Priority Data
Sep. 29, 2005 (KR) 2005-0091680
Dec. 28, 2005 (KR) 2005-0132642

(51) Int. Cl. G05F 1/10

(52) U.S. Cl. 327/539

(57) ABSTRACT

A band gap reference voltage generation circuit includes a reference voltage output node; a current distributing block coupled between the reference voltage output node and a ground voltage terminal, distributing current and supplying a first voltage and a second voltage; an operation amplifying block comparing the first voltage with the second voltage and outputting an operational amplification signal; a current supplying block coupled between a power supply voltage terminal and the reference voltage output node and supplying current to the current distributing block in response to the operational amplification signal; and a variable resistor coupled to an output node for the operational amplification signal.

### FIELD OF THE INVENTION

The present invention relates to a semiconductor integration circuit, and more particularly, to a band gap reference voltage generation circuit that is insensitive to a temperature change.

### DESCRIPTION OF RELATED ARTS

In general, a band gap reference voltage generation circuit (hereinafter referred to as a BGR circuit) is installed into a semiconductor integrated circuit and supplies a stable bias condition. The BGR circuit supplies a reference voltage of an analog-digital converter (ADC) or digital-analog converter DAC, and the reference voltage is stable to various changes in temperature or process conditions. Recently, as portable devices operating by the battery-based power are being widely commercialized, much research is intensively being done to meet an increasing demand to develop devices that consume less power and operate at low voltage. Thus, a power supply voltage level is reduced to 1.5 V to 2.0 V, and as a result, a reference voltage level generated at the BGR circuit is expected to be reduced to 1.25 V to 1.0 V or less. Such BGR circuit outputs the aforementioned level of the reference voltage Vref regardless of changes in process conditions and temperature using a junction voltage characteristic of a bipolar transistor (i.e., a junction voltage between an emitter and a base of the bipolar transistor) and a thermal voltage characteristic defined according to the equation of VT=kT/q.

FIG. 1 illustrates a circuit diagram of a typical BGR circuit. The BGR circuit includes an operation amplifying block OP AMP, one metal-oxide semiconductor (MOS) transistor MP, two bipolar transistors Q1 and Q2, and first to third resistors R1, R2 and R3. In the BGR circuit, a voltage supplied to a gate of the MOS transistor MP is determined corresponding to the output voltage of the operation amplifying block OP AMP. An amount of current flowing to the MOS transistor MP is determined corresponding to the determined voltage. Thus, an amount of current flowing into the first to third resistors R1, R2 and R3 through the MOS transistor MP can be adjusted. This operation continues until two input terminals of the operation amplifying block OP AMP are supplied with voltages having the same voltage level. When the two input terminals of the operation amplifying block OP AMP receive the same voltage level, a certain level of the reference voltage Vref is supplied to a common node of the first and second resistors R1 and R2. A level of the reference voltage Vref is explained based on the equations defined below. An amount of current flowing to the typical bipolar transistors Q1 and Q2 is defined as follows.
I=Iₛₑ^{VBE/VT} Eq. 1

VT represents a thermal voltage, which is a voltage proportionate to an absolute temperature, i.e., kT/q, where q and k are the amount of electric charge and Boltzmann's constant, respectively.

If the voltages supplied to the two input terminals of the operation amplifying block OP AMP are the same, an amount of current flowing to the third resistor R3 is expressed as the following equation.
I=(Vbe1−Vbe2)/R3 Eq. 2

Amounts of current flowing to the bipolar transistors Q1 and Q2 that have a ratio of N to 1 are defined as follows.
I_{Q1}=Ise^{VBE1/VT}
I_{Q2}=NISe^{VBE2/VT} Eq. 3

On the basis of the above equation 3, and the fact that the two input terminals of the operation amplifying block OP AMP are supplied with the same voltage level (i.e., IQ1/IQ2=R1/R2), a base-emitter voltage difference between the two bipolar transistors Q1 and Q2 is defined as follows.
Vbe1−Vbe2=VT*1n(NR2/R1) Eq. 4

The following equation expresses the reference voltage Vref.
Vref=Vbe1+(R2/R3)*VT*1n(NR2/R1) Eq. 5

According to the equation 5, the reference voltage Vref has a negative coefficient of about −2 mV with respect to temperature, while the thermal voltage VT has a positive coefficient. Thus, adjusting coefficients of (R2/R3) and 1n(NR2/R1) makes the reference voltage Vref less sensitive to a temperature change. In the typical BGR circuit, a voltage supplied to a gate of the MOS transistor MP is determined corresponding to the output voltage of the operation amplifying block OP AMP. Thus, an amount of current flowing to the first to third resistors R1, R2 and R3 can be adjusted by the MOS transistor MP.

However, the typical BGR circuit often has a difficulty in adjusting a minute change in the reference voltage Vref, which is generally caused by a delicate temperature change, only using the first to third static resistors R1, R2 and R3 that are adjusted to generate a consistent level of the reference voltage under a certain temperature range as defined in the equation 5.

### SUMMARY OF THE INVENTION

It is, therefore, an object of the present invention to provide a band gap reference voltage generation circuit that can output a consistent level of reference voltage by adjusting a minute change in the reference voltage usually caused by a temperature change.

In accordance with an aspect of the present invention, there is provided a band gap reference voltage generation circuit, including: a reference voltage output node; a current distributing block coupled between the reference voltage output node and a ground voltage terminal, distributing current and supplying a first voltage and a second voltage; an operation amplifying block comparing the first voltage with the second voltage and outputting an operational amplification signal; a current supplying block coupled between a power supply voltage terminal and the reference voltage output node and supplying current to the current distributing block in response to the operational amplification signal; and a variable resistor coupled to an output node for the operational amplification signal.

In accordance with another aspect of the present invention, there is provided a band gap reference voltage generation circuit, including: a reference voltage output node; a current distributing block coupled between the reference voltage output node and a ground voltage terminal, distributing current and supplying a first voltage and a second voltage; an operation amplifying block comparing the first voltage with the second voltage and outputting an operational amplification signal; a current supplying block coupled between a power supply voltage terminal and the reference voltage output node and supplying current to the current distributing block in response to the operational amplification signal; and a variable resistor coupled to an output node for the operational amplification signal to change a voltage level of the operational amplification signal in response to a changing resistance value due to a change in temperature.

In accordance with still another aspect of the present invention, there is provided an operational amplifier, including: an output node for an amplification signal; a differential input transistor block receiving first and second voltages through respective gates thereof; a current mirror type loading block coupled between a power supply voltage terminal and the differential input transistor block; a current sink block coupled between a ground voltage terminal and the differential input transistor block and operating in response to a bias voltage; and a variable resistor coupled between the differential input transistor block and the output node for the amplification signal.

### BRIEF DESCRIPTION OF THE DRAWINGS

The above and other objects and features of the present invention will become better understood with respect to the following description of the exemplary embodiments given in conjunction with the accompanying drawings, in which:

FIG. 1 illustrates a typical BGR circuit;

FIG. 2 illustrates a BGR circuit in accordance with an embodiment of the present invention;

FIG. 3 illustrates a graph of temperature versus voltage supplied to a gate of a P-type channel metal-oxide semiconductor transistor of a current supplying block in accordance with an embodiment of the present invention;

FIG. 4 illustrates comparative simulation results between a reference voltage of the typical BGR circuit and that of a BGR circuit according to an embodiment of the present invention; and

FIG. 5 illustrates comparative simulation results on a reference voltage versus a power supply voltage according to various ranges of temperature when using the typical BGR circuit and a BGR circuit according to an embodiment of the present invention.

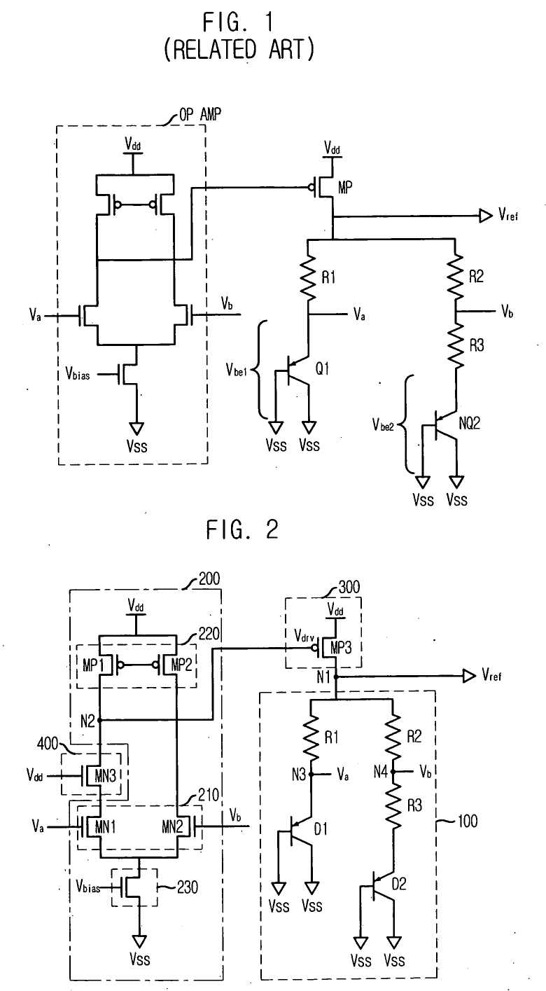

### DETAILED DESCRIPTION OF THE INVENTION

An operational amplifier and a band gap reference voltage generation circuit including the same in accordance with various embodiments of the present invention will be described in detail with reference to the accompanying drawings.

FIG. 2 illustrates circuit diagram of a band gap reference voltage generator according to an embodiment of the present invention. The band gap reference voltage generator includes a reference voltage output node N1, a current distributing block 100, an operation amplifying block 200, a current supplying block 300, and a variable resistor 400. The current distributing block 100 is coupled between the reference voltage output node N1 and a terminal of a ground voltage Vss. Also, the current distributing block 100 supplies a first voltage Va and a second voltage Vb using current that increases or decreases depending on a temperature change. The operation amplifying block 200 compares the first voltage Va with the second voltage Vb and outputs an operational amplification signal. The current supplying block 300 is coupled between a terminal of a power supply voltage Vdd and the reference voltage output node N1 and supplies current to the current distributing block 100 in response to the operational amplification signal. The variable resistor 400 is coupled to an output node N2 for the operational amplification signal and makes a voltage level of the operation amplifying signal increase or decrease based on resistance that increases or decreases as temperature increases or decreases.

Since the configuration and operation of the above elements of the band gap reference voltage generator except for the variable resistor 400 are substantially the same as those of the BGR circuit, detailed description thereof will be omitted. The operation amplifying block 200 including the variable resistor 400 will be described in detail herein below.

The operation amplifying block 200 includes an input transistor MN1 receiving the first voltage Va, and the variable resistor 400 includes an N-type channel metal-oxide semiconductor (NMOS) transistor MN3 coupled between the output node N2 and one terminal of the input transistor MN1 and receiving a power supply voltage Vdd through a gate of the NMOS transistor MN3.

The operation amplifying block 200 includes the output node N2 for outputting the operational amplification signal, a differential input transistor unit 210, a current mirror type loading unit 220, and a current sink unit 230. The differential input transistor unit 210 includes the input transistor MN1, which is the NMOS transistor as described above, and will be referred to as a first NMOS transistor hereinafter. Also, the differential input transistor unit 210 also includes a second NMOS transistor MN2. The differential input transistor unit 210 receives the first and second voltages Va and Vb through respective gates of the first and second NMOS transistors NM1 and NM2. The current mirror type loading unit 220 is coupled between the terminal of the power supply voltage Vdd and the differential input transistor unit 210, and includes first and second P-type channel metal-oxide semiconductor (PMOS) transistors MP1 and MP2. The current sink unit 230 is coupled between the terminal of the ground voltage Vss and the differential input transistor unit 210.

If the second voltage Vb is lower than the first voltage Va, the conductance of the first NMOS transistor MN1 is greater than that of the second NMOS transistor MN2. The second PMOS transistor MP2 supplies driving current for the second NMOS transistor MN2. An amount of current that is substantially the same as that flowing through the second PMOS transistor MP2 flows through the first PMOS transistor MP1 and the first NMOS transistor MN1. Therefore, the voltage of the output node N2 decreases. On the contrary, if the second voltage Vb is higher than the first voltage Va, the conductance of the second NMOS transistor MN2 is greater than that of the first NMOS transistor NM1, and an amount of current greater than that flowing to the first NMOS transistor NM1 flows to the second NMOS transistor MN2. Under this state, the first NMOS transistor MN1 cannot discharge a sufficient amount of the current flowing through the first PMOS transistor MP1, and the output node N2 of the operation amplifying block 200 has an increased level of voltage.

In the present embodiment, the variable transistor 400 is placed between the first NMOS transistor MN1 and the output node N2 of the operation amplifying block 200. Thus, as the temperature increases, the variable resistance of the variable transistor 400 also increases. As a result, the voltage of the output node N2 of the operation amplifying block 200, i.e., the voltage supplied to a gate of a third PMOS transistor MP3, increases, resulting in a decrease in the reference voltage Vref. Hence, as the temperature increases, a rate that the reference voltage Vref of the BGR circuit according to the present embodiment decreases is lower than the rate that the reference voltage Vref of the typical BGR circuit decreases. As the temperature decreases, a rate that the reference voltage Vref of the BGR circuit according to the present embodiment increases is lower than the rate that the reference voltage Vref of the typical BGR circuit increases. Therefore, when the temperature changes, variation in the reference voltage Vref according to the present embodiment is less than the variation in the reference voltage Vref of the typical BGR circuit.

The current supplying block 300 is coupled between the terminal of the power supply voltage Vdd and the reference voltage output node N1 and, includes the PMOS transistor MP3 supplied with the operational amplification signal through the gate thereof. Thus, the increasing or decreasing output voltage of the operation amplifying block 200, i.e., depending on the operational amplification signal, a degree of ‘on’ state of the PMOS transistor MP3 changes, thereby adjusting an amount of current to be supplied to the current distributing block 100 through the PMOS transistor MP3.

The current distributing block 100 includes first to third resistors R1 to R3 and first and second diodes D1 and D2. The first resistor R1 and the first diode D1 are coupled in series between the reference voltage output node N1 and the terminal of the ground voltage Vss. The second and third resistors R2 and R3 and the second diode D2 are coupled in series between the reference voltage output node N1 and the terminal of the ground voltage Vss. A coupling node between the first resistor R1 and the first diode D1 becomes an output node N3 for the first voltage Va, and a coupling node between the second resistor R2 and the third resistor R3 becomes an output node N4 for the second voltage Vb.

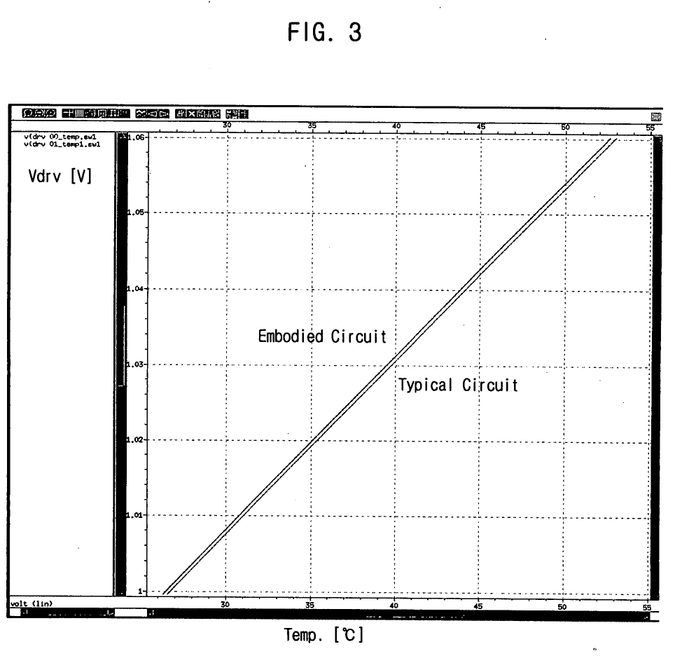

FIG. 3 illustrates a graph of temperature versus voltage supplied to a gate of a PMOS transistor of a current supplying block according to an embodiment of the present invention. As the temperature increases, the voltage Vdrv supplied to the gate of the PMOS transistor of the current supplying block according to the present embodiment increases to a greater extent as compared with the voltage Vdrv supplied to the gate of the PMOS transistor of the typical current supplying block.

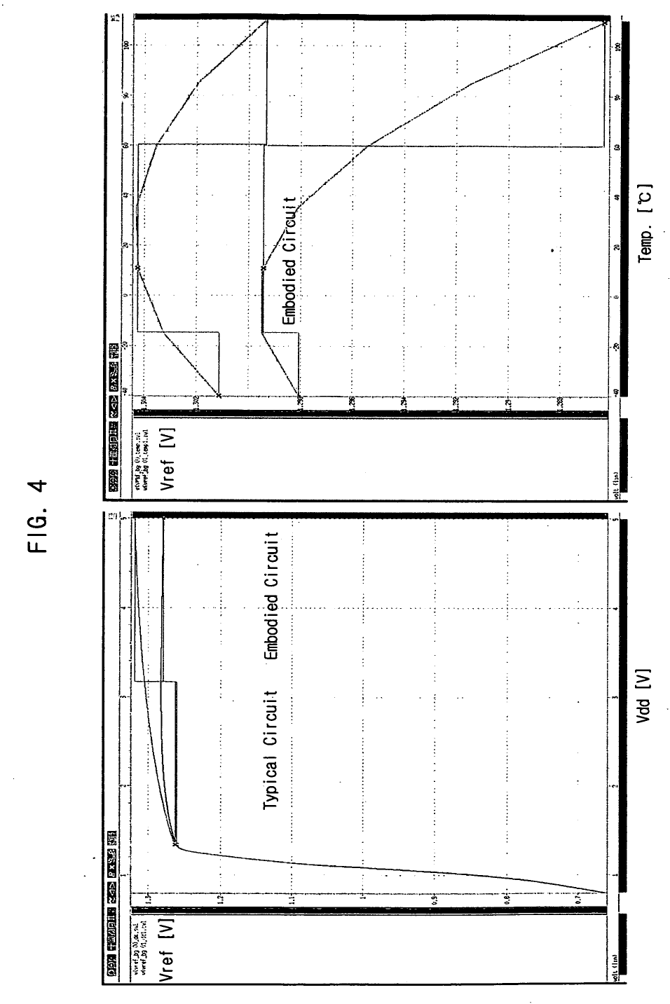

FIG. 4 illustrates comparative simulation results between a reference voltage of the typical BGR circuit and that of a BGR circuit according to an embodiment of the present invention. Particularly, the graph shows a degree of change in the reference voltage Vref when the temperature is about −40 degrees, and the reference voltage level changes from about 0 V to about 5 V. Taking a voltage of about 1.25 V as a reference voltage, the reference voltage Vref change in the BGR circuit according to the present embodiment is less than the reference voltage Vref change in the typical BGR circuit. Also, when the temperature changes from about −40 degrees to about 125 degrees, the reference voltage Vref decreases. At this time, a rate of change in the reference voltage Vref of the BGR circuit according to the present embodiment is lower than the rate of change in the reference voltage Vref of the typical BGR circuit. As the temperature decreases, a rate that the reference voltage Vref of the BGR circuit according to the present embodiment increases is lower than the rate that the reference voltage Vref of the typical BGR circuit increases.

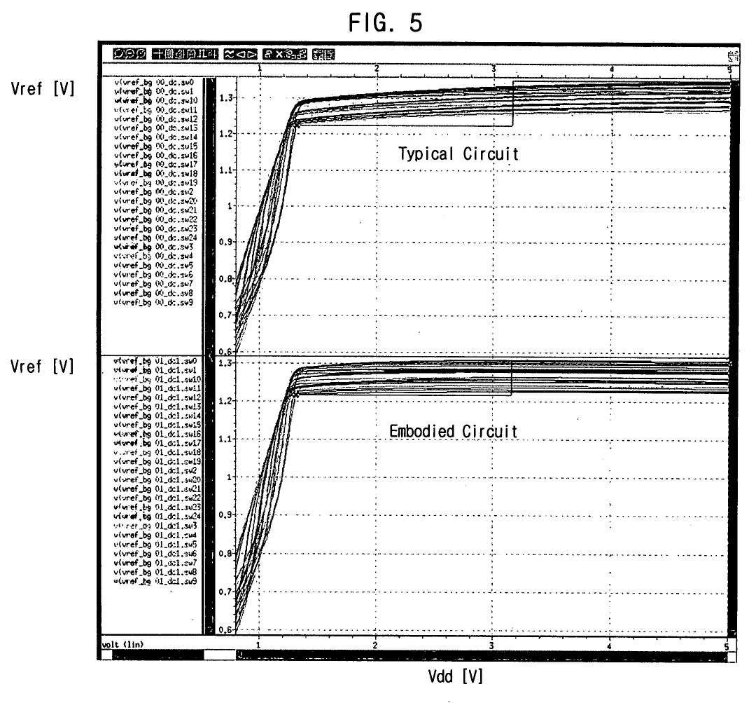

FIG. 5 illustrates comparative simulation results on a reference voltage versus a power supply voltage according to various ranges of temperature when using the typical BGR circuit and a BGR circuit according to an embodiment of the present invention. A degree of voltage change with respect to a temperature change in the BGR circuit according to the present embodiment is less than the degree of voltage change with respect to the temperature change in the typical BGR circuit.

The configuration and operation based on the exemplary embodiments of the present invention allows the BGR circuit to adjust a minute voltage change, usually caused by the temperature change. Also, the operation amplifying block 200 including the variable resistor 400 can be applied to other devices in addition to the band gap reference voltage generator. Particularly, the operation amplifying block 200 can be applied to any device that uses an operational amplification signal that instructs an increase or decrease of a voltage level according to the temperature.

The present application contains subject matter related to the Korean patent application Nos. KR 2005-0091680 and KR 2005-0132642, filed in the Korean Patent Office respectively on Sep. 29, 2005, and on Dec. 28, 2005, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. A band gap reference voltage generation circuit comprising:
a reference voltage output node;
a current distributing block coupled between the reference voltage output node and a ground voltage terminal, distributing current and supplying a first voltage and a second voltage;
an operation amplifying block comparing the first voltage with the second voltage and outputting an operational amplification signal;
a current supplying block coupled between a power supply voltage terminal and the reference voltage output node and supplying current to the current distributing block in response to the operational amplification signal; and
a variable resistor coupled to an output node for the operational amplification signal.

2. The band gap reference voltage generation circuit of claim 1, wherein the operation amplifying block comprises an input transistor receiving the first voltage.

3. The band gap reference voltage generation circuit of claim 2, wherein the variable resistor comprises an N-type channel metal-oxide semiconductor (NMOS) transistor coupled between the output node for the operational amplification signal and one terminal of the input transistor receiving the first voltage and having a gate receiving a power supply voltage.

4. The band gap reference voltage generation circuit of claim 1, wherein the operation amplifying block comprises:
the output node for the operational amplification signal;
a differential input transistor unit receiving the first voltage and the second voltage through respective gates thereof;
a current mirror type loading unit coupled between the power supply voltage terminal and the differential input transistor unit; and
a current sink unit operating in response to a bias voltage and coupled between the ground voltage terminal and the differential input transistor unit.

5. The band gap reference voltage generation circuit of claim 1, wherein the current supplying block comprises a P-type channel metal-oxide semiconductor (PMOS) transistor coupled between the power supply voltage terminal and the reference voltage output node and having a gate receiving the operational amplification signal.

6. The band gap reference voltage generation circuit of claim 1, wherein the current distributing block comprises:
a first resistor and a first diode coupled in series between the reference voltage output node and the ground voltage terminal; and
a second resistor, a third resistor and a second diode coupled in series between the reference voltage output node and the ground voltage terminal, wherein a coupling node between the first resistor and the first diode becomes an output node for the first voltage, and a coupling node between the second resistor and the third resistor becomes an output node for the second voltage.

7. A band gap reference voltage generation circuit comprising:
a reference voltage output node;
a current distributing block coupled between the reference voltage output node and a ground voltage terminal, distributing current and supplying a first voltage and a second voltage;
an operation amplifying block comparing the first voltage with the second voltage and outputting an operational amplification signal;
a current supplying block coupled between a power supply voltage terminal and the reference voltage output node and supplying current to the current distributing block in response to the operational amplification signal; and
a variable resistor coupled to an output node for the operational amplification signal to change a voltage level of the operational amplification signal in response to a changing resistance value due to a change in temperature.

8. The band gap reference voltage generation circuit of claim 7, wherein the operation amplifying block comprises an input transistor receiving the first voltage.

9. The band gap reference voltage generation circuit of claim 8, wherein the variable resistor comprises an N-type channel metal-oxide semiconductor (NMOS) transistor coupled between the output node for the operational amplification signal and one terminal of the input transistor receiving the first voltage and having a gate receiving a power supply voltage.

10. The band gap reference voltage generation circuit of claim 7, wherein the operation amplifying block comprises:
the output node for the operational amplification signal;
a differential input transistor unit receiving the first voltage and the second voltage through respective gates thereof;
a current mirror type loading unit coupled between the power supply voltage terminal and the differential input transistor unit;
a current sink unit operating in response to a bias voltage and coupled between the ground voltage terminal and the differential input transistor unit.

11. The band gap reference voltage generation circuit of claim 7, wherein the current supplying block comprises a P-type channel metal-oxide semiconductor (PMOS) transistor coupled between the power supply voltage terminal and the reference voltage output node and having a gate receiving the operational amplification signal.

12. The band gap reference voltage generation circuit of claim 7, wherein the current distributing block comprises:
a first resistor and a first diode coupled in series between the reference voltage output node and the ground voltage terminal; and
a second resistor, a third resistor and a second diode coupled in series between the reference voltage output node and the ground voltage terminal, wherein a coupling node between the first resistor and the first diode becomes an output node for the first voltage, and a coupling node between the second resistor and the third resistor becomes an output node for the second voltage.

13. An operational amplifier comprising:
an output node for an amplification signal;
a differential input transistor block receiving first and second voltages through respective gates thereof;
a current mirror type loading block coupled between a power supply voltage terminal and the differential input transistor block;
a current sink block coupled between a ground voltage terminal and the differential input transistor block and operating in response to a bias voltage; and
a variable resistor coupled between the differential input transistor block and the output node for the amplification signal.

14. The operational amplifier of claim 13, wherein the variable resistor comprises an NMOS transistor coupled between the output node for the operational amplification signal and the differential input transistor block and having a gate receiving a power supply voltage.
